(19) United States
(12) Patent Application Publication
(10) Pub. No.: US 2008/0179017 A1
(43) Pub. Date: Jul. 31, 2008

(54) Separator system for a control mechanism of a window covering or window shade

(76) Inventors: Fu-Lai Yu, Taipei Hsieh (TW); Chin-Tien Huang, Taipei Hsieh (TW)

Correspondence Address: Olson & Cepuritis, LTD., 20 NORTH WACKER DRIVE, 36TH FLOOR, CHICAGO, IL, 60606, US

(21) Appl. No.: 12/009,468

(22) Filed: Jan. 18, 2008

Related U.S. Application Data
(60) Provisional application No. 60/897,456, filed on Jan. 25, 2007.

(51) Int. Cl. A47H 5/14; E06B 9/06

(52) U.S. Cl. 160/84.05; 160/84.08

(57) ABSTRACT

The present invention relates to a window shade or a window covering having a control mechanism for raising and lowering the window covering. The control mechanism is provided with a separator system. In particular, the present invention relates to a control mechanism with a separator system that provides a disengagement function to prevent or minimize damage to the control mechanism as a result of unintended force on the window shade or window covering. The separator system utilizes a body movable between a mated position where a clutch axle and a winding axle move synchronously, and an unmated position where the winding axle is allowed to rotate independent of the clutch axle.

### CROSS-REFERENCE TO RELATED APPLICATION

This application claims the priority of Provisional Application for Patent Ser. No. 60/897,456 filed on Jan. 25, 2007 which is incorporated herein by reference.

### FIELD OF INVENTION

The present invention relates to a window shade or window covering utilizing a separator system for a control mechanism of the window shade or window covering. In particular, the present invention relates to a control mechanism for a window covering providing a disengagement function that may be utilized to prevent or minimize damage to the control mechanism as a result of unintended force on the window shade or window covering.

### BACKGROUND OF INVENTION

There are numerous types of window shades and window coverings. Examples of such include Venetian blinds, Roman shades, and cellular shades. Typically such window shades and window coverings include a head rail having a light blocking or light shading element suspended from the head rail by one or more suspension cords. These window shades and window coverings also usually include a bottom rail that is also suspended from the head rail to provide additional weight to extend and straighten the light blocking or light shading element. Positioning of the suspension cords is adjustable through different mechanisms including cord locks, clutches, and winding drums. For example, with a clutch based control mechanism, a user controls the raising and lowering of the window covering by pulling on a control cord, which causes the clutch to drive the rotation of the clutch axle. Rotation of the clutch axle in one direction causes the suspension cords to unwind and lower the window covering. Raising of the window covering may be accomplished by applying an upward force to the bottom rail such that the clutch rotates the clutch axle in a second direction that winds the suspension cords and raises the window covering.

A problem that occurs with window coverings utilizing a clutch control mechanism that has been observed is that the user sometimes will attempt to lower the window covering by pulling down on the bottom rail rather than by through use of the control cord. When a user pulls down on the bottom rail and forces the window covering closed in this manner, the clutch mechanism may be irreversibly damaged.

What is needed is a device that provides for separating excessive force exerted directly on a window covering from the clutch control mechanism such that the damage that may be caused thereto is avoided. The present invention meets these desires and overcomes the shortcomings of the prior art.

### SUMMARY OF THE INVENTION

The present invention is directed to a separation system for a control mechanism in a window covering. An embodiment of the present invention is a control mechanism including a torque-selective separator positioned on a drive axle upon which is also positioned a clutch mechanism. The drive axle comprises a clutch axle and a winding axle.

The clutch mechanism may be a conventional clutch mechanism as is known in the art of window coverings. The clutch mechanism is preferably mounted about the clutch axle so as to cause the clutch axle to rotate in the desired manner. The clutch mechanism may also be connected to a control cord. When a user pulls on the control cord, the clutch causes the clutch axle to rotate. Under normal operating conditions, rotation of the clutch axle causes concurrent rotation of the winding axle such that the as the winding axle is rotated, the suspension cords are wound about one or more winding drums, and thereby, raising the window covering. Any clutch mechanism known or that may become known for use in a window covering may be utilized with the present invention.

Mounted on and in a coaxial relationship with the drive axle is the separator system. The separator system is preferably formed from a body having a first portion and a second portion that are mated to one another to form the body. The body also comprises a first end and a second end. The first end defines a first recess that is configured to closely surround and circumscribe a distal end portion of the clutch axle. The second end similarly defines a second recess that is configured to closely surround and circumscribe a proximal end portion of the winding axle. Preferably, the first portion of the body and the second portion of the body each define a portion of the first and second recess. Preferably, the walls of the first and second recesses are rigid, and do not flex when force is exerted upon the walls. The first and second recess may be separated by a center partition if desired.

It is preferred that the first and second recesses define a cross section that substantially matches the cross section of the portion of the drive axle, e.g., the clutch axle or winding axle, that is circumscribed. Preferably, the drive axle is non-resilient and does not compress when force is exerted upon the drive axle. Preferably, the drive axle does not contain a cavity or slot that would allow the width of the axle to be reduced in response to compression force.

The drive axle and corresponding recess can define a cross section of any shape so long as the shape of the cross section creates a frictional force between the drive axle and recess when the drive axle is rotated. Such frictional force can be created from a variety of cross section components, including, but not limited to the corners of a polygonally shaped cross-section, the non-symmetrical sides of an oval-shaped cross-section, or ribs, teeth, or other protrusions projecting from a generally circular cross-section.

The drive axle preferably defines a polygonal cross section. For example, the drive axle may define a square-shaped cross section. In this example, the first and second recesses would define a square-shaped cross section through which the drive axle is passed and closely circumscribed. The drive axle may also define a generally circular cross section, such as an oval-shaped cross section, in which case the first and second recesses would also define a generally circular cross section. The drive axle may also define a generally circular cross section with ribs, teeth or other protrusions projecting from its outer surface. In such a case, the first and second recesses would define a circular cross section containing slits, groves or other indentations that complement the protrusions of the projecting from the drive axle.

Preferably, the first and second portions of the body provide equal portions of the recess such that the body is rotationally balanced about the drive axle.

In some embodiments the cross section of the first and second recess need not match the cross section of the clutch axle or winding axle. Instead, for example, a square shaped cross section clutch axle and winding axle may be used with an octagonal recess.

The first portion and the second portion of the body are movable relative to one another such that they are moveable from a mated position to an unmated position. In the mated position, the first portion and the second portion form the recess in the separator and are preferably held together by at least one biasing member, such as a spring clip. Any biasing members known in the art can be used to hold together the first portion and the second portion. Such biasing members include elastic bands, magnets, or any variety of spring.

When the first portion and second portion of the body are in a mated position, the separator is preferably press fit with the drive axle. Under normal conditions, the press fit enables rotational force of the clutch axle to be transferred to the winding axle. As such, as the clutch is manipulated by the user through pulling on the control cord, the clutch axle is rotated, which causes concurrent rotation of the winding axle.

As discussed above, a problem that has been observed occurs when a user attempts to lower the window covering by pulling on the bottom rail or accidentally pulls on the bottom rail. This excessive force on the bottom rail, in prior art systems, caused damage to the clutch mechanism. With the present invention, when an excessive force is exerted on the winding axle by way of a pulling force being exerted on the suspension cords, e.g., a user pulling on the bottom rail suspended by the suspension cords, the separator enables the force to not be exerted on the clutch mechanism.

For example, when the first portion and second portion of the body are in a mated position, as a force is exerted on the winding axle, this force is transferred via the separator to the clutch axle and the clutch mechanism. If the amount of force exceeds a threshold level, which is less than the amount of force that would cause damage to the clutch, the winding axle is caused to rotate relative to the separator. As the winding axle rotates, due to the shape of the cross section thereof, the force exerted by the spring clip is overcome and the first portion and the second portion of the body are pried apart from one another and moved into an unmated position. As such, the winding axle is therefore able to rotate independent of the clutch axle, and the force exerted upon the winding axle is not transferred to the clutch axle or the clutch mechanism.

In one embodiment, the cross sections of the clutch axle and the winding axle—as well as the first recess and the second recess—are of a regular polygon, such as a square. With the square-shaped cross section example, as the winding axle is rotated one quarter turn relative to the clutch axle, the spring clips cause the first and second portions of the body to return to a mated position. If the excessive force is still being exerted, the first and second portions of the body will again be pried apart and the winding axle rotated a quarter turn independent of the clutch axle, and then the body is returned to a mated position by the spring clips. This process continues until the force exerted on the winding drum does not exceed the threshold level. This threshold amount of force depends on the clutch mechanism in use. The threshold amount of force need only be less than whatever amount of force would cause damage to the clutch mechanism.

In the embodiment discussed, the body of the separator is constructed with an assembly of two movable parts between which are defined the recesses for the axles. The number of parts can be any plurality desired. Also in the embodiment discussed, the clutch axle is detachably secured to the separator such that as the body is moved to an unmated position, the clutch axle can rotate relative to the separator. In an alternative embodiment, the clutch axle may be fixedly secured to the separator instead of by way of a press fit mount. In this alternative embodiment only the portion of the body that connects to the winding axle is moveable or adjustable to allow rotation of the winding axle relative to the separator, and in turn, relative to the clutch.

In the previous embodiment, the coaction of the rotation of the winding axle and the compression of the spring clips cause the body of the separator to automatically move between a mated and an unmated position. In another alternative embodiment, the mechanism utilized to press fit the body to the axle may be releasable, yet not automatically re-engaged with the axle. In other words, if the threshold amount of force is exerted on the winding axle, the body of the separator is moved to an unmated position and thereby allowing the winding axle to rotate independent of the clutch axle, but is not caused to automatically return to a mated position. Instead, the reestablishment of the separator with the winding axle is achieved manually.

The present invention has thus far been discussed in the context of a device utilized to prevent damage to a clutch mechanism. The present invention may also be used to provide a control mechanism for a window covering that may be operated either by a control cord, or by way of directly pulling or raising of the bottom rail, such as with a cordless window covering. In other words, the separator system may enable a user to pull down on the bottom rail of a window covering to lower the light blocking element, but not damage the clutch mechanism. Raising of the bottom rail is then achieved by applying an upward force to the bottom rail. If desired, the same control mechanism can include control cords to allow the user to raise and lower the window covering with the control cord.

In yet another embodiment, the control mechanism may include a biasing mechanism such as found in cordless window covering applications. Examples of suitable devices are found in pending application Ser. No. 11/591,718, which was filed on Nov. 2, 2006 and application Ser. No. 11/392,340, which was filed on Mar. 29, 2006, each of which are incorporated herein by reference. An upward bias on the bottom rail and the commensurate rotational force on the winding axle may be provided by the biasing mechanism. When the user lifts directly on the bottom rail, the force exerted by the biasing mechanism may overcome the compressive force of the spring clips such that the winding axle is disengaged from the clutch axle, and the winding axle is then enabled to raised the window covering without transferring the rotational force to the clutch mechanism.

### BRIEF DESCRIPTION OF THE DRAWINGS

In the drawings,

FIG. 1 is a perspective view of a cellular window shade utilizing a separator system for a control mechanism in accordance with an embodiment of the present invention;

FIG. 2 is a top plan view of a head rail of FIG. 1;

FIG. 3 is a partial perspective view of the separator system engaged with the drive axle and in a mated position;

FIG. 4 is a partial side elevational cross sectional view the separator system of FIG. 3;

FIG. 5 is a partial perspective view of the separator system disengaged from the drive axle and in an unmated position;

FIG. 6 is a partial side elevational cross sectional view the separator system of FIG. 5;

FIG. 7 is side-elevation view of the separator system engaged with the drive axle and in a mated position wherein the drive axle and first recess have an oval shaped cross-section;

FIG. 8 is a side-elevation view of the separator system shown in FIG. 7 disengaged from the drive axle and in an unmated position;

FIG. 9 is side-elevation view of the separator system engaged with the drive axle and in a mated position wherein the drive axle has a generally circular cross-section containing U-shaped protrusions and the first recess has a generally circular cross-section with U-shaped indentations; and

FIG. 10 is side-elevation view of the separator system engaged with the drive axle and in a mated position wherein the drive axle has a generally circular cross-section containing V-shaped protrusions and the first recess has a generally circular cross-section with V-shaped indentations.

### DESCRIPTION OF PREFERRED EMBODIMENT

The invention disclosed herein is susceptible to embodiment in many different forms. The embodiment shown in the drawings and described in detail below is only for illustrative purposes. The disclosure is intended as an exemplification of the principles and features of the invention, but does not limit the invention to the illustrated embodiments.

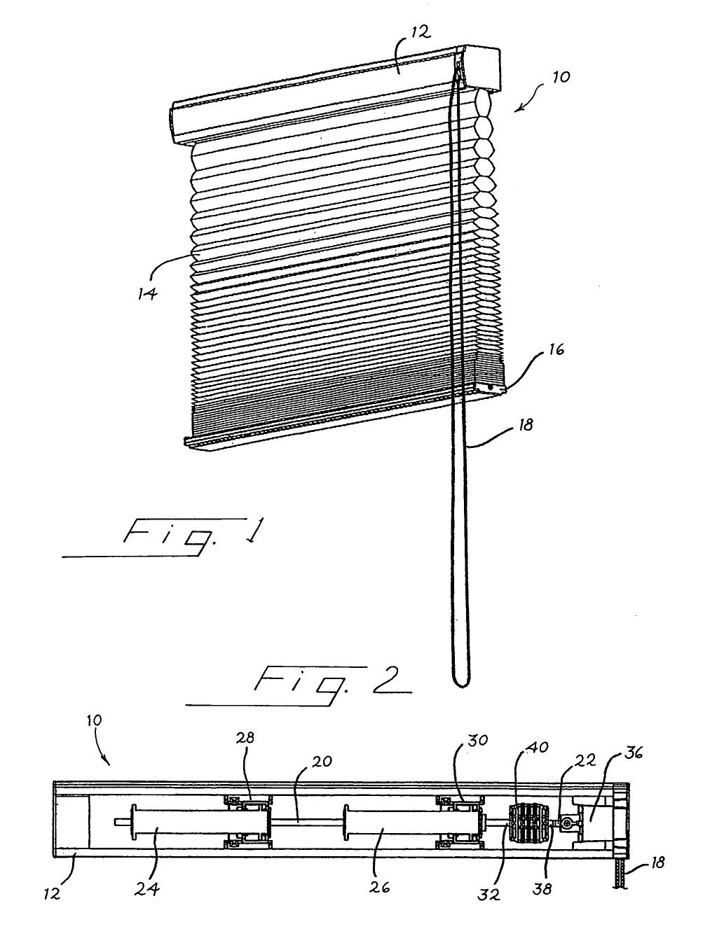

Referring to FIG. 1, a cellular window 10 covering is shown. Window covering 10 includes a head rail 12, a light blocking element, such as cellular structure 14, a bottom rail 16, a control cord 18, and suspension cords (not shown). Window covering 10 may be opened by raising bottom rail 16 towards head rail 12 such that cellular structure 14 is collapsed and gathered on the bottom rail 16. Raising of the bottom rail 16 may be effected by the user lifting the bottom rail such that the clutch mechanism (FIG. 2) causes the suspension cords to be wound. Alternatively, the manipulation of the control cord 18 can be used to raise the bottom rail 16. Lowering of the bottom rail 16 and closing of the window covering 10 may be done by manipulation of the control cord 18, which causes the clutch mechanism to unwind the suspension cords, and thereby lower the bottom rail.

As discussed, one problem that has been observed is that users of the window covering 10 sometimes attempt to close the window covering by pulling downward on bottom rail 16. Conventional clutch mechanisms are typically designed to lock the window covering in a vertical position so that once positioned, the window covering does not close unintentionally. As such, if a user pulls too hard on the bottom rail, the resultant excessive force against the clutch lock can irreparably damage the clutch.

Referring to FIG. 2, an embodiment of the present invention that remedies the aforementioned problem is shown. Head rail 12 defines a channel in which various control components are located. Provided in the present embodiment is a drive axle comprising a winding axle 20 and a clutch axle 22. The winding axle has mounted thereon a pair of winding drums 24, 26, which are supported by supports 28 and 30. Winding axle 20 defines a proximal end portion 32. Clutch axle 22 defines a proximal end portion 34 that is secured with clutch mechanism 36, and a distal end portion 38. The distal end portion 38 of the clutch axle 22 and the proximal end portion 32 of the winding axle are connected to one another by way of separator system 40. In a preferred embodiment, the surface of the winding axle 20 and the clutch axle 22 is non-resilient and does not substantially compress when force is exerted upon it.

A more detailed explanation of the separator system 40 is provided with reference to FIGS. 3-6. Referring to FIGS. 3 and 4, the separator system 40 is shown secured with winding axle 20 and clutch axle 22. Separator system 40 includes a body 42 having a first portion 44 and a second portion 46. Body 42 generally defines a first end 48 and a second end 50. First portion 44 and second portion 46 are press fitted with the proximal end portion 32 of winding axle 20 and distal end portion 38 of clutch axle 22 by spring clips 52 and 54.

When first portion 44 and second portion 46 are in a mated position as shown in FIGS. 3 and 4, body 42 defines a first recess 56 extending proximally from the first end 48 and a second recess 58 extending distally from the second end 50. When in the mated position as shown, the first recess 56 and the second recess 58 define a square-shaped cross section. The cross section of the first recess 56 and the second recess 58 are configured to circumscribe the proximal end portion 32 of winding axle 20 and distal end portion 38 of clutch axle 22, respectively. If desired, a partition 60 can be provided to separate the first recess 56 and the second recess 58. In a preferred embodiment, the first recess 56 and second recess 58 contain rigid walls that do not flex when force is exerted upon the walls.

When first portion 44 and second portion 46 are in a mated position, the body 42 of separator 40 connects the winding axle 20 and the clutch axle 22 such that force exerted on either of the winding axle 20 or clutch axle 22 is translated to the other. Thus, in normal operation, the winding axle 20 and clutch axle 22 function as an integral drive axle.

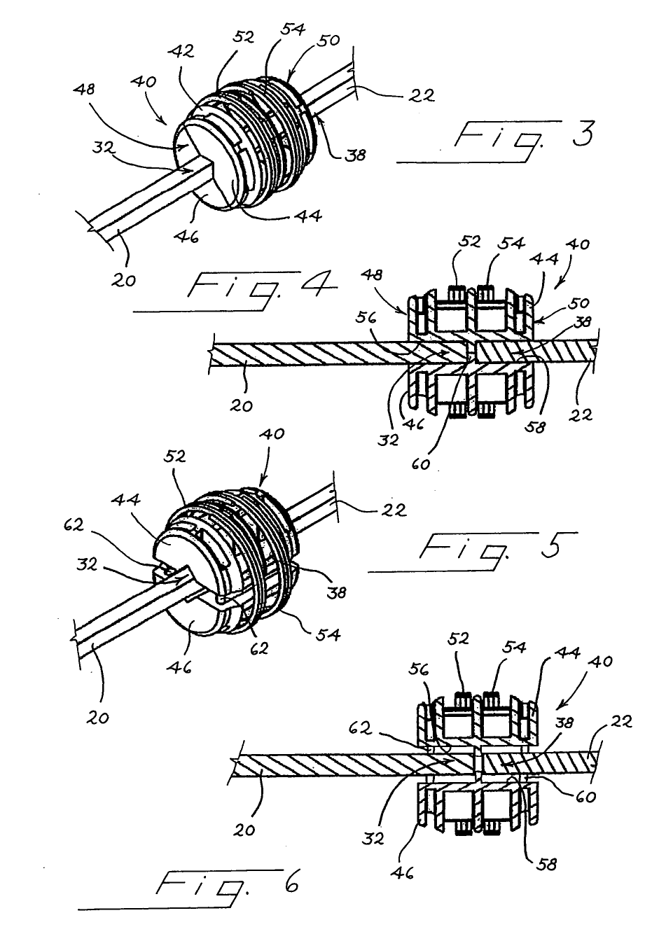

Referring to FIGS. 5 and 6, if a user exerts a pulling force on the bottom rail 16 (FIG. 1) to cause it to lower, a resulting rotational force on winding axle 20 will drive the rotation of the winding axle 20, causing the first portion 44 to separate from the second portion 46 of body 42. Due to the geometries of the winding axle 20, the clutch axle 22, the first recess 56, and the second recess 58, if sufficient force is exerted, the compressive force of spring clips 52 and 54 are overcome. This allows first portion 44 of body 42 to separate from second portion 46 of body 42. As such, winding axle 20 is permitted to rotate independent of the separator 40, as well as the clutch axle 22 and clutch 36. As the winding axle 20 continues to rotate, the geometry of first recess 56 is again brought into alignment with winding axle 20, and spring clips 52 and 54 cause first portion 44 and second portion 46 to return to a mated position such as shown in FIGS. 3 and 4. Guides 60 and 62 may be provided to assist in maintaining the desired alignment of the first portion 44 and the second portion 46. If the excessive force is still being exerted, the first portion 44 and second portion 46 of the body 42 will again be pried apart and the winding axle 20 rotated a quarter turn independent of the clutch axle 22, and then the body 42 is returned to a mated position by the spring clips 52 and 54. This process continues until the force exerted on the winding drum does not exceed the threshold level. Once the excessive force is removed, the first portion 44 and second portion 46 of body 42 stay in a mated position and the clutch axle 22 and winding axle 20 again are connected so as to rotate synchronously. The force exerted by spring clips 52 and 54 in this embodiment can be provided by other mechanisms such as elastic bands, magnets, or springs.

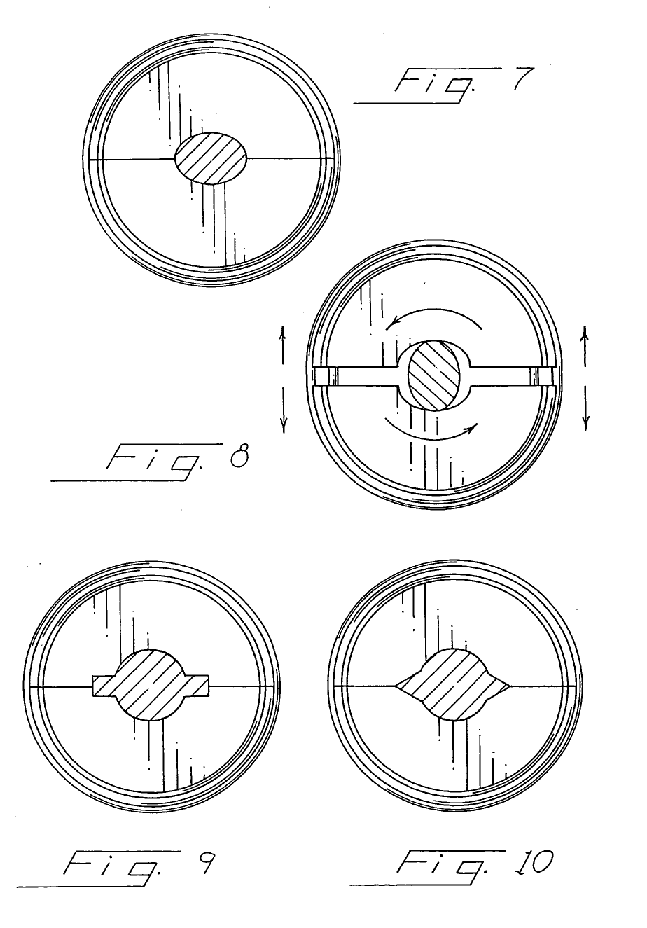

Referring to FIGS. 7 and 8, an alternative embodiment of the separator system 40 is shown with an oval-shaped winding axle 120. The oval-shaped first recess 156 in this embodiment corresponds to the shape of the winding axle 120. The clutch axle and second recess (not shown) of this embodiment may also be oval shaped to create a consistent shape on both sides of the separator 40.

In this embodiment, a rotational force on winding axle 120 in the direction of arrow A or in the direction opposite to arrow A will cause first portion 144 to move in the direction of arrow B and will cause second portion 146 to move in the direction of arrow C. Such movement creates a separation between first portion 144 and second portion 146 such that oval-shaped winding axle 120 is permitted to rotate independent of separator 40.

Referring to FIG. 9, an alternative embodiment of the separator system 40 is shown with a winding axle 220 having a generally circular cross-section. U-shaped protrusions 250 and 252 extend from winding axle 220. The generally circular-shaped first recess 256 of this embodiment contains U-shaped indentations 258 and 260 that correspond to the U-shaped protrusions 250 and 252.

Referring to FIG. 10, another alternative embodiment of the separator system 40 is shown with a winding axle 320 having generally circular cross-section. V-shaped protrusions 350 and 352 extend from winding axle 320. The generally circular-shaped first recess 356 of this embodiment contains U-shaped indentations 358 and 360 that correspond to the V-shaped protrusions 350 and 352.

The positioning of the protrusions is not limited to the positions described in the disclosed embodiments. The protrusions 250, 252 and 350,352 shown in FIGS. 9 and 10 are located on opposite sides of the winding axle 220, 320. The protrusions can also be placed less than 180 degrees apart from each other. Alternatively, one protrusion or more than two protrusions can extend from the winding axle. The indentations in the first recess may also be positioned to correspond with the alternative protrusion placement.

While the embodiments discussed include axles and recesses with square, oval, or circular cross-sections, other shapes can be used. For example, polygonal shapes such as hexagons or octagons can be used. Other generally circular or generally polygonal shapes can be used so long as the shape of the cross section creates a frictional force between the drive axle and recess when the drive axle is rotated.

Although the embodiments discussed describe a spring clip used as a biasing member, other biasing members known in the art can be used to hold together the first portion and the second portion. Such biasing members include elastic bands, magnets, or any variety of spring, including leaf springs, coil springs, and torsion springs.

Another embodiment of the present invention can contain no biasing member at all, such that the body does not automatically re-engage with the axle after the body has been released. In this alternative embodiment, the reestablishment of the separator with the winding axle is achieved manually.

Also, the embodiments discussed describe a separator system wherein the winding axle is disengageable from the separator system. It is also contemplated that the winding axle may be fixedly secured with the separator system, yet the clutch axle may be detachably secured with the separator system. In this configuration, if the rotational force exceeds the threshold level, the winding axle and separator system continue to rotate together while disengaged from the clutch axle.

The foregoing description and the drawings are illustrative of the present invention and are not to be taken as limiting. Other arrangements of the engagement structure may be implemented. Such variations and modifications are within the spirit and the scope of the present invention and will be readily apparent to those skilled in the art in view of the scope of the invention as claimed herein.

We claim:

1. A control mechanism for a window covering, the control mechanism comprising:
a clutch mechanism;
a separator system;
at least one winding member;
a winding axle;
a clutch axle;
the clutch mechanism being mounted coaxially with the clutch axle;
the at least one winding member being mounted coaxially with the winding axle; and
the separator system being mounted coaxially with the clutch axle and the winding axle, the separator system comprising a body positioned between the clutch axle and the winding axle, the body having at least a first portion and a second portion being movable relative to one another between a mated position and an unmated position, the first portion and the second portion of the body further defining a first recess configured to circumscribe the winding axle and a second recess configured to circumscribe the clutch axle, wherein the first portion and the second portion of the body are moveable from the mated position to the unmated position by sufficient rotational force from the winding axle.

2. The control mechanism of claim 1, wherein the first portion and the second portion of the body are biased in the mated position by a biasing mechanism.

3. The control mechanism of claim 1, wherein the first portion and the second portion of the body are placed into the mated position manually.

4. The control mechanism of claim 1, wherein at least one control cord is connected to the clutch mechanism.

5. The control mechanism of claim 1, wherein at least one suspension cord is connected to the winding axle.

6. The control mechanism of claim 1, wherein the winding axle and the clutch axle are incompressible.

7. The control mechanism of claim 1, wherein the first recess and second recess comprise rigid internal walls.

8. A window covering comprising:
a head rail;
a light blocking element;
a bottom rail;
a control cord;
a control mechanism associated with the control cord and positioned within the head rail, the control mechanism comprising a clutch mechanism connected to the control cord, a clutch axle connected to the clutch mechanism, a winding axle associated with at least one suspension cord used to raise and lower the window covering, and a separator system having at least two body portions and having a mated and an unmated position for the portions, the separator system linking the clutch axle to rotate with the winding axle when in the mated position and allowing the winding axle to rotate separately from the clutch axle when in the unmated position.

9. The window covering of claim 8, wherein the at least two body portions define a first recess and a second recess.

10. The window covering of claim 9, wherein the first recess and second recess comprise rigid internal walls.

11. The window covering of claim 8, wherein the winding axle and the clutch axle are incompressible.

12. A separator system for use in a window covering, the separator system comprising:
an axle;
a body comprising at least a first portion and a second portion, the first portion and the second portion being movable relative to one another between a mated position and an unmated position;
a biasing mechanism biasing the first portion and second portion toward the mated position;
a first recess defined by the first portion and the second portion of the body in the mated position, the first recess configured to circumscribe the axle.

13. The separator system of claim 12, wherein the axle rotates at the same rate as the separator system when the first portion and the second portion of the body are in the mated position, and wherein the axle rotates at a different rate than the separator system when the first portion and the second portion of the body are in the unmated position.

14. The separator system of claim 12, further comprising a second axle and a second recess configured to circumscribe the second axle.

15. The separator system of claim 14, wherein the first recess, second recess, axle and second axle are coaxial.

16. The separator system of claim 12, wherein the biasing mechanism comprises a spring clip.

17. The separator system of claim 12, wherein the first recess defines a cross section that substantially matches the cross section of the axle.

18. The separator system of claim 12, wherein the first recess defines a generally polygonal cross section.

19. The separator system of claim 12, wherein the first recess defines a generally circular cross section.

20. The separator system of claim 12, wherein the first recess contains one or more indentations positioned to accommodate one or more protrusions located on the axle.

21. The separator system of claim 12, wherein the axle is incompressible.

22. The separator system of claim 12, wherein the first recess comprises rigid internal walls.
